(19) United States
(12) Patent Application Publication
(10) Pub. No.: US 2009/0053919 A1
(43) Pub. Date: Feb. 26, 2009

(54) CONNECTOR MOUNTING STRUCTURE

(75) Inventors: Tetsuya Murayama, Kawasaki (JP); Junichi Hayama, Kawasaki (JP); Fujio Ozawa, Kawasaki (JP); Hiroyuki Abe, Kawasaki (JP); Hisato Sato, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/258,539

(22) Filed: Oct. 27, 2008

Related U.S. Application Data
(62) Division of application No. 11/188,940, filed on Jul. 25, 2005.

(30) Foreign Application Priority Data
Mar. 30, 2005 (JP) 2005-099886

(51) Int. Cl. H01R 24/04; H01R 13/62

(52) U.S. Cl. 439/153; 439/668

(57) ABSTRACT

A connector mounting structure is disclosed that includes a connector mounted on a substrate. The connector includes plural connector rows that are arranged into a laminated structure. The connector rows include plural connector units that are arranged into rows. The positions of the connector units of a first connector row of the laminated connector rows are shifted with respect to the positions of the connector units of a second connector row that is arranged above the first connector row.

### BACKGROUND OF THE INVENTION

1. Field of the Invention

The present invention relates to a connector mounting structure in which a connector that is formed by laminating plural connector rows each having connector units arranged into a row is mounted on a substrate.

2. Description of the Related Art

Conventionally, a connector is used to connect an electronic apparatus to another electronic apparatus via a cable, for example. In this case, a cable plug is provided at the cable side, and a connector that is arranged to engage the cable plug is provided at the electronic apparatus side. In recent years and continuing, techniques are being developed for miniaturizing such an electronic apparatus implementing such a connector, and in turn, techniques are proposed for miniaturizing the connector (e.g., see Japanese Laid-Open Patent Publication No. 10-340744).

Also, it is noted that in view of the widespread use of broadband technology, a communication apparatus is provided that accommodates massive access side wiring (e.g., for ether signals) and provides multiplexed and line concentrated signals to the transport side. In such a communication apparatus, the RJ-45 connector is generally used. FIGS. 1A, 1B, 2A, and 2B illustrate exemplary connector mounting structures conventionally used in the communication apparatus as is described above.

The connector mounting structure shown in FIGS. 1A and 1B uses two connectors 1A that are arranged into a laminated structure so as to accommodate massive access side wiring. The connector 1A includes a first connector row 3 that is made up of eight connector units 8 that are arranged into a row extending in horizontal directions (represented by arrows X1 and X2 in FIG. 1A), and a second connector row 4 arranged on top of the first connector row 3 that is also made up of eight connector units 8 extending in horizontal directions. The second connector row 4 is laminated on top of the first connector row 3, and the first and second connector rows 3 and 4 are sealed by molded resin 9.

It is noted that the connector unit 8 is arranged to correspond to the RJ-45 connector; that is, eight leads 6/7 are arranged to extend from the back side of the connector unit 8. Specifically, first leads 6 extend from the connector unit 8 making up the first connector row 3, and second leads 7 extend from the connector unit 8 making up the second connector row 4.

The leads 6 and 7 are arranged to extend horizontally for a predetermined length after which they are bent downward. The bottom ends of the bent leads 6 and 7 are connected to lands formed on a printed circuit board 2 through soldering.

The connector mounting structure shown in FIGS. 2A and 2B includes the connector 1A as is described above and a connector 1B that is laminated on top of the connector 1A. The connector 1B includes a third connector row 5 having connector units 8 extending horizontally. The connector unit 8 of the third connector row 5 includes leads 14 that are connected to a sub printed circuit board 12 that is separate from the printed circuit board 2.

As is described above, the connector unit 8 is arranged to correspond to the RJ-45 connector, and this connector 8 engages a plug having a lock release piece (see FIG. 4). Accordingly, a maneuver space h1 is provided between the connectors 1A and 1B for maneuvering the lock release piece. It is noted that such a space is also provided between the two connectors 1A of the connector mounting structure of FIGS. 1A and 1B.

To create the maneuver space h1 between the connectors 1A and 1B for maneuvering the lock release piece, a spacer member 13 is provided at the printed circuit board 2, and the sub printed circuit board 12 is arranged at the top end portion of the spacer member 13.

In the prior art examples described above, obstacles exist with respect to miniaturization of the connector mounting structure. Namely, in the first prior art example illustrated by FIGS. 1A and 1B, two connectors that have identical structures are arranged one on top of the other.

In such an arrangement, the printed circuit board 2 needs to be provided for each connector 1A. Also, the maneuver space h1 for maneuvering the lock release piece has to be provided between the connectors 1A. Therefore, the overall height h2 of the connector mounting structure may be relatively large to thereby hinder miniaturization of the connector mounting structure.

In the second prior art example illustrated by FIGS. 2A and 2B, the maneuver space h1 has to be provided between the connectors 1A and 1B for the same reasons described above, and thereby, the connector mounting structure may not be sufficiently miniaturized. Also, in the prior art example of FIGS. 2A and 2B, the spacer member 13 has to be provided in order to create the maneuver space h1 between the connectors 1A and 1B. Accordingly, the number of components for realizing the connector mounting structure is increased, and the number of processing steps for fabricating the connector mounting structure is increased, to thereby induce an increase in cost.

### SUMMARY OF THE INVENTION

The present invention has been conceived in response to one or more of the problems of the prior art, and its object is to provide a connector mounting structure that is capable of accommodating massive access side wiring and realizing miniaturization without increasing the number of components.

According to an embodiment of the present invention, a connector mounting structure is provided that includes:

a connector mounted on a substrate and including at least three connector rows that are laminated and sealed by resin, the connector rows including plural connector units that are arranged into rows; wherein

the connector units include plural leads that are connected to the one single substrate on which the connector is mounted.

According to an aspect of the present invention, the leads of the connector units of the laminated connector rows are connected to one single substrate, and accordingly, the number of substrates may be reduced compared to the prior art, and a miniaturized connector mounting structure may be realized. According to another aspect of the present invention, the connector rows are sealed by resin, and thereby, a mechanism for supporting a connector row and a substrate provided at the upper side may be unnecessary, and a miniaturized connector mounting structure may be realized.

According to another embodiment of the present invention, a connector mounting structure is provided that includes:

a connector mounted on a substrate and including plural connector rows that are arranged into a laminated structure, the connector rows including plural connector units that are arranged into rows;

wherein the positions of the connector units of a first connector row of the laminated connector rows are shifted with respect to the positions of the connector units of a second connector row that is arranged above the first connector row.

According to an aspect of the present invention, the positions of the connector units of an upper connector row and the positions of the connector units of a lower connector row are shifted with respect to each other, and thereby, interference between the leads extending from the respective connector units of the upper and lower connector rows may be prevented. In turn, high densification of the connector units may be realized, and the connector mounting structure may be miniaturized. In a preferred embodiment of the present invention, the connector unit may be arranged to engage a plug having a lock release piece, and in such a case, the positions of the lock release pieces engaged to the connector units of the upper and lower connector rows may be shifted with respect to each other. In this way, the connector mounting structure may be miniaturized while securing sufficient space for maneuvering the lock release pieces.

According to another embodiment of the present invention, a connector mounting structure is provided that includes:

a connector mounted on a substrate and including plural connector rows that are arranged into a laminated structure, the connector rows including plural connector units that are arranged into rows; wherein

the connector units include upper leads and lower leads that are arranged to be positioned at a height lower than the upper leads with respect to the substrate; and

at least one of the upper leads and at least one of the lower leads are arranged to intersect with each other in plan view with respect to the substrate.

According to an aspect of the present invention, some of the upper leads and lower leads are arranged to intersect with each other in plan view, and thereby, high densification of the leads may be realized so that the connection area on the substrate for connecting the leads may be reduced in size and miniaturization of the connector mounting structure may be realized.

According to a preferred embodiment of the present invention, the connector includes at least three connector rows, and the connector units include plural leads that are connected to the one single substrate on which the connector is mounted.

According to an aspect of the present invention, the leads of the connector units are connected to one single substrate, and thereby, the number of substrates may be reduced compared to the prior art and miniaturization of the connector mounting structure may be realized.

According to another preferred embodiment of the present invention, the connector unit is arranged to engage a plug having a lock release piece.

According to another preferred embodiment of the present invention, the connector unit corresponds to the RJ-45 connector.

According to another preferred embodiment of the present invention, the combined height of the laminated connector rows and the substrate on which the connector rows are laminated is arranged to correspond to an integer multiple of the U pitch.

According to another embodiment of the present invention, an electronic apparatus is provided that uses the connector mounting structure of the present invention to mount a connector to a substrate.

### BRIEF DESCRIPTION OF THE DRAWINGS

FIGS. 1A and 1B are diagrams illustrating a connector mounting structure according to a first prior art example;

FIGS. 2A and 2B are diagrams illustrating a connector mounting structure according to a second prior art example;

FIGS. 3A and 3B are diagrams illustrating a connector mounting structure according to a first embodiment of the present invention, FIG. 3A corresponding to an elevation view and FIG. 3B corresponding to a cross-sectional view of the connector mounting structure;

FIG. 4 is a diagram illustrating a plug that is engaged to a connector;

FIGS. 5A and 5B are diagrams illustrating a connector mounting structure according to a second embodiment of the present invention, FIG. 5A corresponding to an elevation view and FIG. 5B corresponding to a cross-sectional view of the connector mounting structure;

FIG. 6 is a diagram illustrating an arrangement of leads of the connector mounting structure according to the second embodiment;

FIGS. 7A-7C are diagrams illustrating a plug-in unit implementing the connector mounting structure of the second embodiment;

FIGS. 8A-8C are diagrams illustrating an electronic apparatus implementing the connector mounting structure of the second embodiment;

FIGS. 9A and 9B are diagrams illustrating a connector mounting structure according to a third embodiment of the present invention, FIG. 9A corresponding to an elevation view and FIG. 9B corresponding to a cross-sectional view of the connector mounting structure;

FIG. 10 is a diagram illustrating an arrangement of leads of the connector mounting structure according to the third embodiment;

FIG. 11 is a cross-sectional view illustrating a connector mounting structure according to a fourth embodiment of the present invention;

FIG. 12 is a perspective view of an arrangement of leads of the connector mounting structure according to the fourth embodiment; and

FIG. 13 is a plan view of the arrangement of leads according to the fourth embodiment.

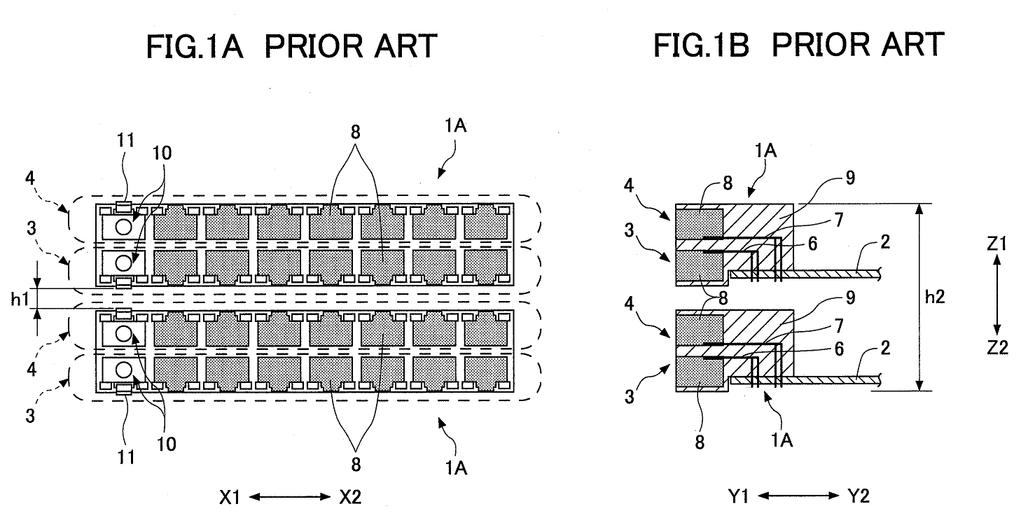

### DESCRIPTION OF THE PREFERRED EMBODIMENTS

In the following, preferred embodiments of the present invention are described with reference to the accompanying drawings.

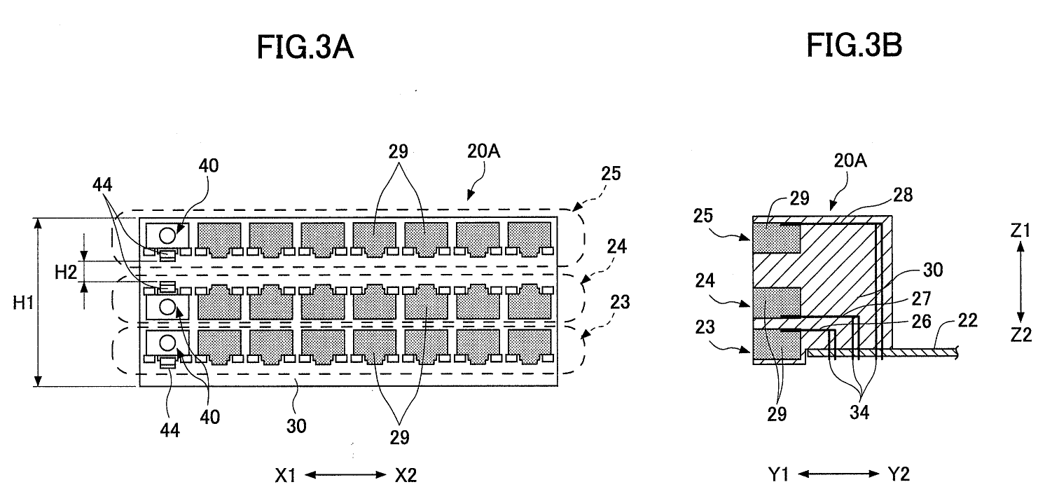

FIGS. 3A and 3B are diagrams illustrating a connector mounting structure according to a first embodiment of the present invention. A connector 20A of the connector mounting structure shown in the present drawings may correspond to a connector used in a communication apparatus accommodating massive access side wiring and being arranged to provide multiplexed and line concentrated signals to the transport side, for example. Also, a connector unit 29, which is described below, may be arranged to have a structure corresponding to that of the RJ-45 connector.

To enable accommodation of massive access side wiring, the connector mounting structure of the present embodiment includes a first connector row 23, a second connector row 24, and a third connector row 25 that are arranged into a laminated structure. Each of the connector rows 23˜25 includes eight connector units 29 that are arranged into a row extending in horizontal directions (represented by arrows X1 and X2 in FIG. 3A).

The connector unit 29 of the connector rows 23˜25 correspond to the connector RJ-45, and has eight leads extending from its back side. Specifically, first leads 26 extend from the connector units 29 of the first connector row 23, second leads 27 extend from the connector units 29 of the second connector row 24, and third leads 28 extend from the connector units 29 of the third connector row 25.

The first through third leads 26˜28 are arranged to extend horizontally for a predetermined length after which they are bent downward in a substantially perpendicular direction. The bottom ends of the bent leads 26˜28 are connected to lands 34 formed on a printed circuit board 22 through soldering.

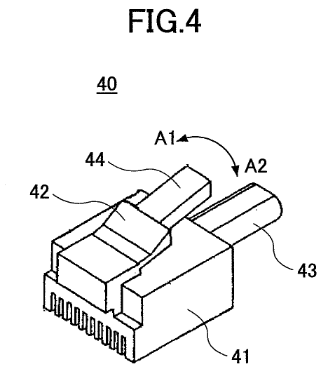

In the following, a plug 40 that is engaged to the connector unit 29 is described. FIG. 4 is a diagram showing a structure of the plug 40 that is engaged to the connector unit 29. The plug 40 includes a plug body 41 that is connected to a cable 43. When the plug body 41 is inserted into the connector unit 29, electrical connection may be realized between the plug 40 and the corresponding lead 26, 27, or 28 of the connector unit 29.

The plug 40 also includes a lock release piece 42 for preventing the plug 40 from being detached from the connector 20A (connector unit 29). The lock release piece 42 is integrally formed with a lever portion 44 and is arranged to be capable of flexibly deforming in directions indicated by arrows A1 and A2 in FIG. 4. The connector unit 29 includes a lock portion that engages the lock release piece 42.

When the plug 40 is engaged to the connector unit 29 and the plug body 41 is inserted into the connector unit 29, the lock release piece 42 elastically deforms in the direction indicated by arrow A2, after which the lock release piece 42 elastically reverts (toward the direction indicated by arrow A1) to its original state upon reaching a predetermined insertion position so as to be engaged to the lock portion of the connector unit 29. In this way, detachment of the plug 40 from the connector 20A (connector unit 29) may be prevented.

In the case of removing the plug 40 from the connector 20A (connector unit 29), the lever portion 44 may be maneuvered toward direction A2, to thereby release the engagement between the lock release piece 42 and the lock portion so that the plug 40 may be pulled out from the connector 20A (connector unit 29). As is described above, the lever portion 44 has to be maneuvered upon removing the plug 40 from the connector 20A (connector unit 29), and accordingly, a maneuver space has to be provided at the connector 20A. In the present embodiment, a space H2 is provided between the second connector row 24 and the third connector row 25, and this space H2 corresponds to the space for allowing maneuvering of the lever portion 44.

Referring back to FIGS. 3A and 3B, the connector 20A is described further. The laminated first through third connector rows 23˜25 are sealed and fixed by molded resin 30. In the following descriptions, emphasis is placed on the electrical connections of the first through third leads 26˜28 extending from the connector units 29 of the first through third connector rows 23˜25. It is noted that in the present embodiment, the first through third leads 26˜28 are connected to one common printed circuit board 22.

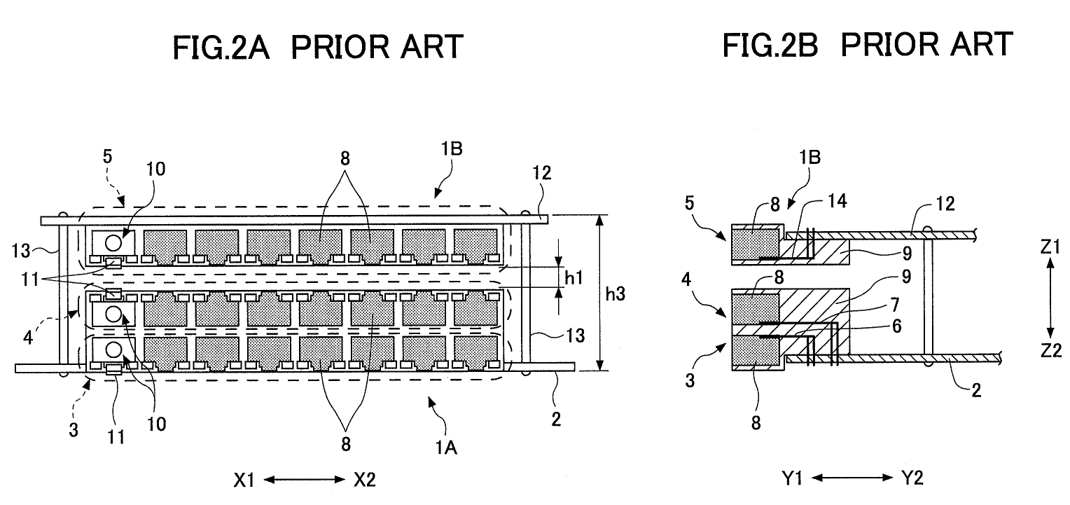

By arranging the leads 26˜28 of the connector units 29 of plural connector rows 23˜25 to be connected to one common printed circuit board 22, the number of substrates may be reduced compared to the prior art (e.g., FIGS. 2A and 2B), and the connector 20A may be miniaturized. Also, by sealing the plural connector rows 23˜25 with molded resin 30, the spacer member 13 used for supporting the connector 1B in the prior art example illustrated by FIGS. 2A and 2B may be unnecessary in the present embodiment, and thereby, the number of components may be reduced leading to cost reduction. In addition, since the space required for providing the spacer member 13 becomes unnecessary, the connector 20A may be further miniaturized.

By implementing the connector mounting structure according to the present embodiment, the height H1 of the connector 20A may be reduced to approximately 90% of the height of the connector mounting structure according to the prior art example illustrated in FIGS. 2A and 2B (i.e., H1≈h3×0.9). By realizing a reduction in the height of the connector 20A, the combined height of the connector 20A and the printed circuit board 22 may easily be arranged to correspond to an integer multiple of the U pitch (1 U pitch=44.45 mm).

In the following, a second embodiment of the present invention is described.

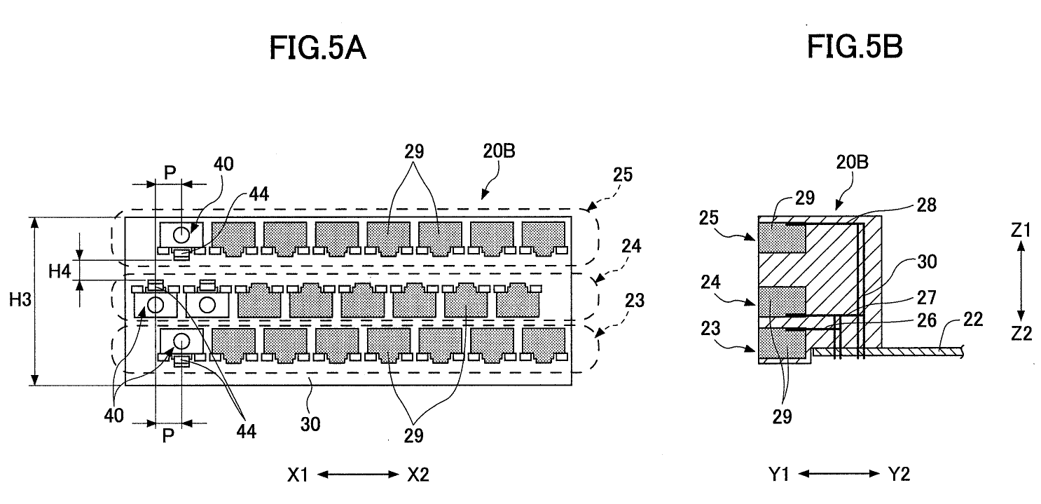

FIGS. 5A-8C are diagrams illustrating a connector mounting structure according to a second embodiment of the present invention. It is noted that in these drawings, elements that are identical to those described in relation to the first embodiment (FIGS. 3A and 3B) are assigned the same reference nnumerals, and their descriptions are omitted.

The connector mounting structure according to the second embodiment also includes first through third connector rows 23˜25 that are arranged into a laminated structure, and the connector rows 23˜25 are sealed by molded resin 30. Accordingly, the number of components may be reduced, and cost reduction and miniaturization may be realized with respect to the prior art. In the connector mounting structure according to the present embodiment, the positions of the connector units 29 of a lower connector row and the positions of the connector units 29 of an upper connector row arranged on top of the lower layer connector row are shifted with respect to each other.

Specifically, with regard to the first connector row 23 and the second connector row 24, the positions of the connector units 29 of the second connector row 24 are shifted in the direction X1 with respect to the positions of the connector units 29 of the first connector row 23 by half the mounting pitch of the connector units 29 (i.e., by pitch P shown in FIG. 5A).

According to the present embodiment, when the plugs 40 are engaged to the connector units 29, the positions of the lever portions 44 (lock release pieces 42) of the plugs 40 engaged to the upper connector row and the positions of the lever portions 44 (lock release pieces 42) of the plugs 40 engaged to the lower connector row are shifted by pitch P in the horizontal directions (i.e., directions X1 and X2). With such an arrangement, interference between the upper side and lower side lever portions 44 (lock release pieces 42) at the maneuvering space may be prevented so that the maneuver space H4 for the present embodiment may be reduced.

Specifically, in the first embodiment, a maneuver space with dimension H2 (see FIG. 3A) is required. In the second embodiment, the required maneuver space may be reduced to H4 as is shown in FIG. 5A (i.e., H4<H2). In this way, the connector 20B according to the present embodiment may be reduced in size while securing sufficient space for effectively maneuvering the lever portion 44 (lock release piece 42) at the same time.

Also, by shifting the positions of the connector units 29 of the lower connector row with respect to the positions of the connector units 29 of the upper connector row, the leads 26˜28 extending from the back sides of the connector units 29 in the Y2 direction are also shifted according to their corresponding connector rows. In this way, high densification of the lands 34 provided on the printed circuit board 22 for connecting the leads 26˜28 to the printed circuit board 22 may be realized, and the connector 20B according to the present embodiment may be further miniaturized.

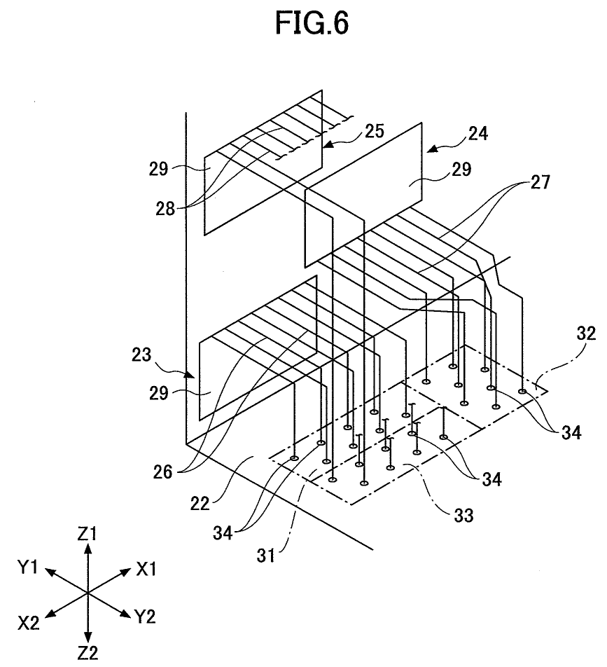

In the following, the above described advantage of the present embodiment is described in greater detail with reference to FIG. 6. It is noted that in FIG. 6, one connector unit 29 of each of the connector rows 23˜25 is shown for the sake of convenience.

According to the present embodiment, the connector units 29 of a connector row and the connector units 29 of another connector row positioned directly above or below this connector row are shifted from each other by half the mounting pitch of the connector units 29 (i.e., by pitch P shown in FIG. 5A). Accordingly, the positions of the connector units 29 of the first connector row 23 and the positions of the connector units 29 of the third connector row 25 correspond with respect to the X1-X2 directions whereas the positions of the connector units 29 of the second connector row 24 are shifted from the positions of the connector units 29 of the first and third connector rows 23 and 25 in the X1-X2 directions by the pitch P.

Accordingly, the region provided with lands 34 for connecting the first leads 26 extending from the connector units 29 of the first connector row 23 to the printed circuit board 22 (first connection region 31 defined by dashed lines in FIG. 6) and the region provided with lands 34 for connecting the third leads 28 extending from the connector units 29 of the third connector row 25 to the printed circuit board 22 (third connection region 33 defined by dashed lines in FIG. 6) are arranged to be aligned in the Y1-Y2 directions.

On the other hand, since the connector units 29 of the second connector row 24 are shifted with respect to the connector units 29 of the first and third connector rows 23 and 25, the region provided with lands 34 for connecting the second leads 27 extending from the second connector units of the second connector row 24 to the printed circuit board 22 (second connection region 32 defined by dashed lines in FIG. 6) is shifted from the first and second connection regions 31 and 33 with respect to the X1-X2 directions.

With such an arrangement, the overall width in the Y1-Y2 directions of the first through third connection regions 31˜33 may be reduced compared to the first embodiment. Specifically, in the first embodiment, as is shown in FIG. 3B, the lands 34 for connecting the first through third leads 26˜28 are all aligned in the Y1-Y2 directions. In this case, the width in the Y1-Y2 directions of the region on the printed circuit board 22 that is provided with lands 34 for connecting the first through third leads 26˜28 is greater than that of the second embodiment.

As can be appreciated from the above descriptions, according to the second embodiment, the overall width of the first through third connection regions 31˜33 in the Y1-Y2 directions may be reduced compared to the first embodiment, and in turn, the required space for mounting the connector 20B on the printed circuit board 22 may be reduced with respect to the Y1-Y2 directions. Also, the lengths of the second and third leads 27 and 28 may be shortened compared to the prior art, and thereby, disturbance in the leads 27 and 28 and undesired irradiation from the leads 27 and 28 may be reduced so that the EMI (Electro Magnetic Interference) characteristics may be improved.

It is noted that the first through third leads 26˜28 extending from the connector units 29 of the first through third connector rows 23˜25, respectively, are also connected to one common substrate 22 in the present embodiment. Therefore, as with the first embodiment, the number of substrates may be reduced in the connector 20B according to the second embodiment, and the connector 20B may be miniaturized compared to the prior art. By implementing the connector mounting structure according to the second embodiment, the height of the connector 20B may be reduced to approximately 80% of the height of the connector used in the prior art example illustrated by

FIGS. 2A and 2B (i.e., H3≈h3×0.8).

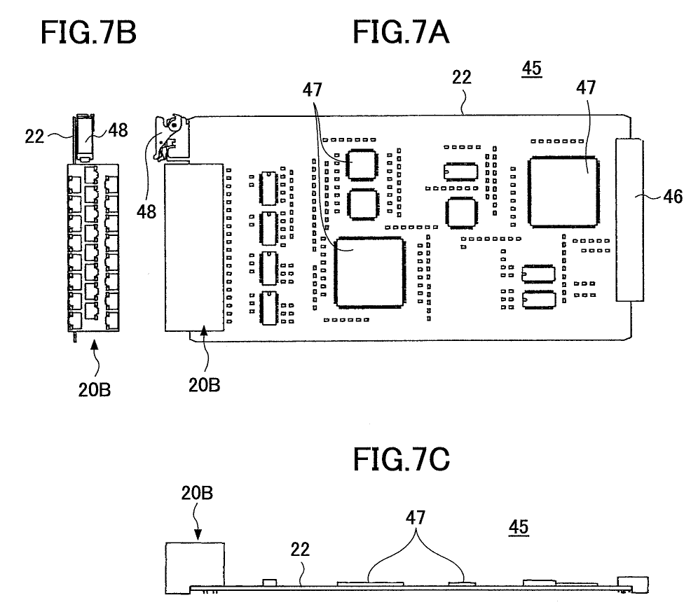

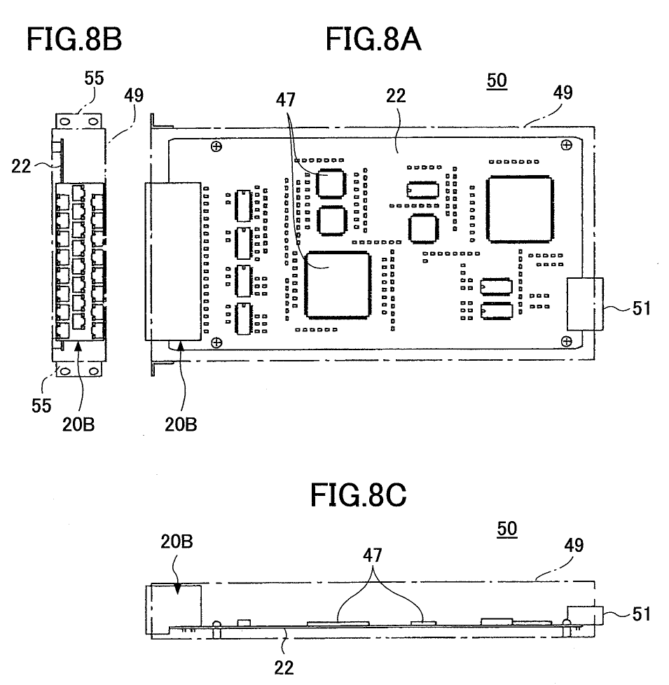

FIGS. 7A-7C and FIGS. 8A-8C illustrate exemplary applications of the connector 20B mounting structure according to the second embodiment. FIGS. 7A-7C illustrate an exemplary application of the connector 20B mounting structure of the second embodiment to a plug-in unit 45. The illustrated plug-in unit 45 is arranged to be inserted into a shelf of a rack, and a card lever 48 is arranged to be locked to the shelf when this plug-in unit 45 is mounted.

When the plug-in unit 45 is mounted on the shelf, a sheet connector 46 that is provided at an opposite side edge position with respect to the mounting position of the connector 20B of the printed circuit board 22 (i.e., rear side of the shelf) is engaged to a connector provided at the shelf. It is noted that in the illustrated example, electronic components 47 are provided on the printed circuit board 22.

FIGS. 8A-8C illustrate an example of applying the connector 20B mounting structure according to the second embodiment on an electronic apparatus 50. The electronic apparatus 50 includes a housing case 49 inside which the printed circuit board 22 with the connector 20B is accommodated.

The illustrated electronic apparatus 50 may be mounted in a rack by arranging an edge portion 55 of the housing case 49 to be stationed in the rack at a predetermined mounting angle. Also, when the electronic apparatus 50 is mounted, a power source cable is connected to a power source terminal 51 that is provided at an opposite side edge position with respect to the mounting position of the connector 20B of the printed circuit board 22 (i.e., rear side of the shelf).

In the following, a third embodiment of the present invention is described.

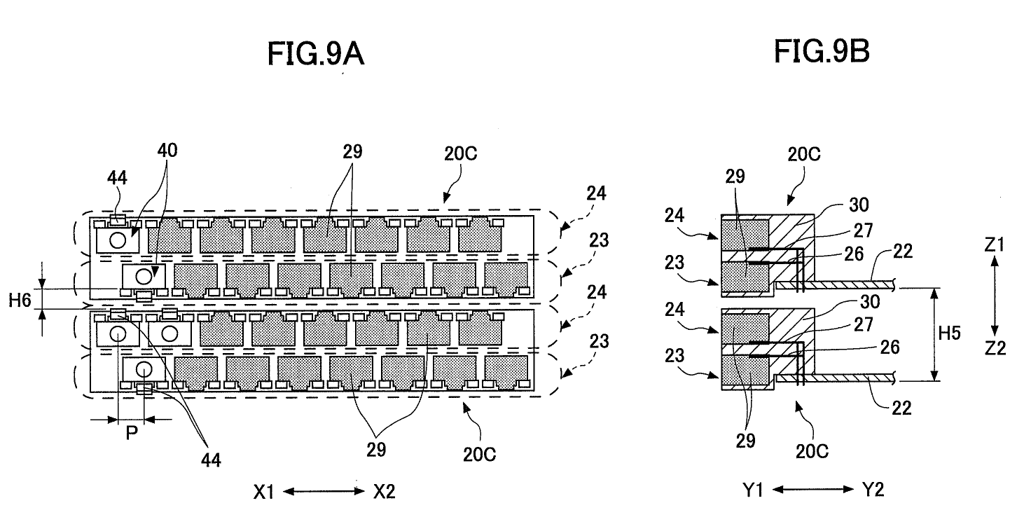

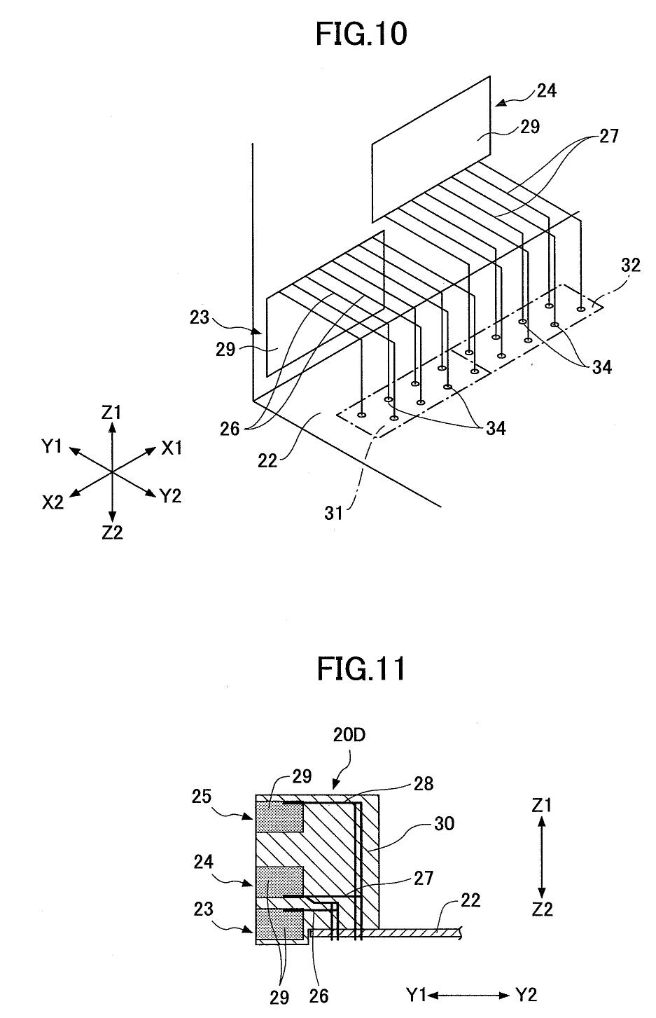

FIGS. 9A, 9B, and FIG. 10 illustrate a connector mounting structure according to the third embodiment. It is noted that in these drawings, elements that are identical to those described in relation to the first embodiment (FIGS. 3A and 3B) are assigned the same reference numerals and their descriptions are omitted.

In the connector mounting structure according to the present embodiment, two connectors 20C are arranged in a laminated structure. The connector 20C includes a first connector row 23 having eight connector units 29 that are arranged horizontally (i.e., X1-X2 directions in FIG. 9A) and a second connector row 24 placed above the first connector row 23 also having eight connector units 29 that are arranged horizontally.

According to the present embodiment, the second connector 24 row is laminated on the first connector row 23, and the connector units 29 of the first connector row 23 and the connector units 29 of the second connector row 24 are shifted with respect to each other by half the mounting pitch of the connector units 29 (i.e., by pitch P shown in FIG. 9A) in the X1-X2 directions.

When the two connectors 20C are laminated one on top of the other, the connector units 29 of the second connector row 24 of the lower side connector 20C and the connector units 29 of the first connector row 23 of the upper side connector 20C are shifted with respect to each other by half the mounting pitch of the connector units 29 (i.e., by pitch P shown in FIG. 9A) in the X1-X2 directions.

In this way, the connector units 29 at the two opposing sides of the dual connector 20C laminated structure (i.e., the connector units 29 of the second connector row 24 of the lower connector 20C and the connector units 29 of the first connector row 23 of the upper connector) may be shifted with respect to each other by pitch P in the X1-X2 directions. In this way, the maneuver space for the respective lever portions 44 (lock release pieces 42) of the plugs 40 positioned at the upper side and the lower side may be prevented from interfering with each other so that the maneuver space for the lever portions 44 (lock release pieces 42) may be reduced. Accordingly, the layered connector 20C structure may be miniaturized while securing a sufficient maneuver space for maneuvering the lever portions 44 (lock release pieces 42).

Also, since the connector units 29 of the second connector row 24 of the lower connector 20C and the connector units 29 of the first connector row 23 of the upper connector are arranged to be shifted from each other by pitch P in the X1-X2 directions in the present embodiment, first and second leads 26 and 27 extending (in the X2 direction) from the back sides of the respective connector units 29 of the first and second connector rows of the connectors 20C are shifted from each other in the X1-X2 directions.

As is shown in FIG. 10, in the present embodiment, the region of the lands 34 for connecting the first leads 26 extending from the connector units 29 of the first connector row 23 to the printed circuit board 22 (first connection region 31 indicated by dashed lines in the drawing) and the region of the lands 34 for connecting the second leads 27 extending from the connector units 29 of the second connector row 24 to the printed circuit board 22 (second connection region 32 indicated by dashed lines in the drawing) are shifted with respect to each other in the Y1-Y2 directions.

With such an arrangement, the overall width in the Y1-Y2 directions of the first and second connection regions 31 and 32 may be reduced, and the required space for mounting the connectors 20C on the printed circuit board 22 may be reduced with respect to the Y1-Y2 directions.

In the following, a fourth embodiment of the present invention is described.

FIGS. 11-13 are diagrams illustrating a connector mounting structure according to the fourth embodiment. It is noted that in these drawings, elements that are identical to those described in relation to the first embodiment (FIGS. 3A and 3B) are assigned the same reference numerals and their descriptions are omitted.

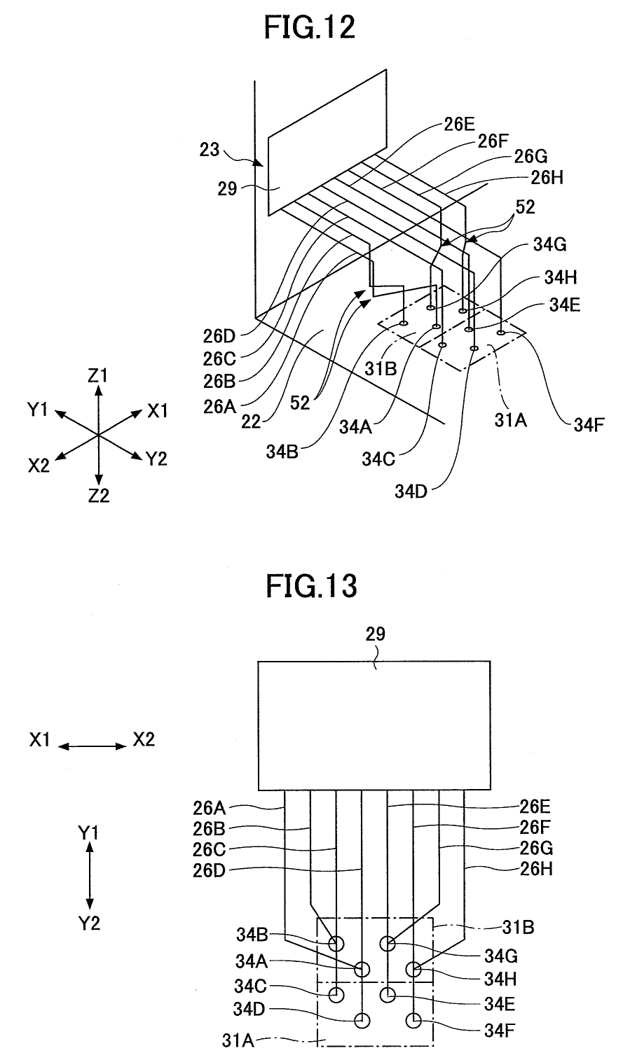

It is noted that as with the previously described embodiments, each connector unit 29 is provided with eight leads in the present embodiment. In FIGS. 12 and 13, the connector unit 29 of the first connector row 23 is shown to represent the arrangement of leads of the connector unit 29 according to the present embodiment. In the previously described embodiments of the present invention, the leads extending from the back side of the connector unit 29 are arranged to extend for a predetermined length in the Y2 direction after which they are bent downward in a substantially perpendicular direction (Z2 direction) to be connected to the lands 34 of the printed circuit board 22.

In the present embodiment, of the eight leads 26A-26H that are aligned in the X1-X2 directions, four leads 26C-26F that are located at the center are arranged to extend from the back side of the connector unit 29 in a manner similar to that described in relation to the previous embodiments. On the other hand, the leads 26A, 26B, 26G, and 26H located at the sides are arranged to have stepped portions 52. Specifically, as is shown in FIG. 12, the leads 26A, 26B, 26G, and 26H are arranged to extend in the Y2 direction for a predetermined length after which they are bent downward in a substantially perpendicular direction (Z2 direction) and bent again in a substantially perpendicular direction to extend horizontally (i.e., parallel to the plane of the leads 26C-26F) and underneath the plane of the leads 26C-26F. In this way, the stepped portions 52 of the leads 26A, 26B, 26G, and 26H are formed.

With such an arrangement, the leads 26A, 26B, 26G, and 26H are arranged to be positioned at a lower height than the leads 26C-26F, and thereby, the leads 26A, 26B, 26G, and 26H may be placed underneath the leads 26C-26F. Also, the leads 26A, 26B, 26G, and 26H and the leads 26C-26F may appear to intersect each other in plan view (i.e., with respect to the XY plane).

Specifically, as is shown in FIG. 13 (corresponding to a plan view of the leads 26A-26H), a land 34A for connecting the lead 26A to the printed circuit board 22 is positioned directly below the lead 26D. Similarly, a land 34B for connecting the lead 26B to the printed circuit board 22 is positioned directly below the lead 26C, a land 34G for connecting the lead 26G to the printed circuit board 22 is positioned directly below the lead 26E, and a land 34H for connecting the lead 26H to the printed circuit board 22 is positioned directly below the lead 26F. Also, leads 26A and 26C appear to intersect each other and leads 26F and 26G appear to intersect each other in plan view.

According to the present embodiment, by reducing the heights of the leads 26A, 26B, 26G, and 26H with respect to those of the leads 26C-26F, flexibility may be realized with respect to the layout of the leads 26A-26H. In this way, a connection region 31B of the lands 34A, 34B, 34G, and 34H for connecting the leads 26A, 26B, 26G, and 26H to the printed circuit board 22 may be positioned closer to the connector unit 29 (toward the Y1 direction) compared to the position of a connection region 31A of the lands 34C-34F for connecting the leads 26C-26F to the printed circuit board 22. Thereby, high densification of the leads 26A-26H may be realized, and the connection regions 31A and 31B for the lands 34A-34 formed on the printed circuit board 22 may be reduced in size. Also, the leads 26A-26H may be shortened so that the EMI (Electro Magnetic Interference) characteristics may be improved.

Further, the present invention is not limited to these embodiments, and variations and modifications may be made without departing from the scope of the present invention.

The present application is based on and claims the benefit of the earlier filing date of Japanese priority application No. 2005-099886 filed on Mar. 30, 2005, the entire contents of which are hereby incorporated by reference.

What is claimed is:

1. A connector mounting structure, comprising:
a connector mounted on a substrate and including a plurality of connector rows that are arranged into a laminated structure, the connector rows including a plurality of connector units that are arranged into rows;
wherein positions of the connector units of a first connector row of the laminated connector rows are shifted with respect to positions of the connector units of a second connector row that is arranged above the first connector row.

2. The connector mounting structure as claimed in claim 1, wherein the connector includes at least three connector rows, and the connector units include a plurality of leads that are connected to the one single substrate on which the connector is mounted.

3. The connector mounting structure as claimed in claim 1, wherein at least one of the connector units is arranged to engage a plug including a lock release piece.

4. The connector mounting structure as claimed in claim 1, wherein at least one of the connector units corresponds to a RJ-45 connector.

5. The connector mounting structure as claimed in claim 1, wherein a combined height of the laminated connector rows and the substrate is arranged to correspond to an integer multiple of a U pitch.

6. An electronic apparatus, comprising:
a substrate; and
a connector mounted on the substrate and including a plurality of connector rows that are arranged into a laminated structure, the connector rows including a plurality of connector units that are arranged into rows;
wherein positions of the connector units of a first connector row of the laminated connector rows are shifted with respect to positions of the connector units of a second connector row that is arranged above the first connector row.
